(19) United States
(12) Patent Application Publication
(10) Pub. No.: US 2023/0206207 A1
(43) Pub. Date: Jun. 29, 2023

(54) METHOD AND SYSTEM FOR RESOLVING A TARGET

(71) Applicant: TBCASOFT, INC., Sunnyvale, CA (US)

(72) Inventors: William WU, Sunnyvale, CA (US); Brian CHAN, Sunnyvale, CA (US)

(21) Appl. No.: 17/996,079

(22) PCT Filed: Apr. 14, 2021
(86) PCT No.: PCT/US2021/027370

§ 371 Date: Oct. 13, 2022

Related U.S. Application Data
(60) Provisional application No. 63/010,015, filed on Apr. 14, 2020.

(51) Int. Cl. G06Q 20/22; G06Q 20/40; G06Q 20/32

(52) U.S. Cl. CPC G06Q 20/223; G06Q 20/4014; G06Q 20/3276; G06Q 20/3278; G06Q 2220/00

(57) ABSTRACT

Disclosed are a method and a system for resolving a target, which employ two-stage target resolution. A local resolving peer resolves the target at a first-stage target resolution. If the first-stage target resolution fails, the first resolving peer sends target-related information to at least one remote resolving peer for second-stage target resolution in return of a resolvable result indicating that the target is resolvable to corresponding type of identifier. To avoid congested traffic arising from broadcasting target-related information without discrimination to the at least one remote resolving peer, a scheme caching approach and a hint service approach are adopted. Transmission of target-related information can be conducted either concurrently or sequentially in response to traffic condition. Accordingly, the method and the system of the present invention reliably resolve a target with known or unknown format at two stages without compromising the efficiency for target resolution.

### BACKGROUND OF THE INVENTION

### 1. Field of the Invention

The present invention relates to a method and system for resolving a target and, more particularly, to a method and system for resolving a target from original target information to at least one identifier corresponding to a target resolution type associated with mobile transactions.

### 2. Description of the Related Art

Global village has certainly promoted more and more international travel activities across the world no matter whether they are for business or for recreation. Owing to payment for purchasing merchandise and services in foreign countries arising from these activities, credit cards have been one of the popular choices for settling such cross-border payment for years.

Contactless payment through a personal mobile device may be new but commonplace in many countries such as Taiwan and a myriad of Asian and African countries while consumers elsewhere still favor credit card payment, cash, transfer, or cheques. Because of sanitary issues, such as the recent pandemic spread, which deter the use of PIN pads, contactless transactions using QR (Quick Response) code and NFC (Near-field Communication) technologies are becoming increasingly important and gaining unprecedented popularity.

However, the original target information in QR code or NFC tag, which is converted to a target for a transaction and is generated by a customer device or a merchant device utilizing different payment services, such as Pay Pay from SoftBank, AliPay from Alibaba, or the like, is not standardized yet in terms of its data format or addressing-scheme and therefore varies from payment service to payment service. For example, a QR code generated by a device utilizing SoftBank payment service could not be recognized and resolved to a corresponding target for payment to a merchant store in Taiwan which only accepts the QR codes generated by a device utilizing Taiwan payment services. Under the circumstance, a target resolving service capable of recognizing the addressing-scheme of the original target information of a customer or a merchant and resolving the target in the original target information is needed.

### SUMMARY OF THE INVENTION

An objective of the present invention is to provide a method and system for resolving a target with an emphasis on a reliable and efficient target resolution for a subsequent transaction.

To achieve the foregoing objective, the method for resolving a target includes:

(a) a local resolving peer receiving the target and a target resolution type from a subscriber communicatively connected to the local resolving peer;

(b) the local resolving peer determining if the target is resolvable to at least one identifier corresponding to the target resolution type;

(c) when the target is not resolvable at the absence of an internal error, the local resolving peer transmitting the target resolution type, and the target to at least one remote resolving peer, wherein the local resolving peer and the at least one remote resolving peer are a part of multiple resolving peers communicatively connected to a cross-peer transaction network; and

(d) the local resolving peer determining if the target is resolvable based on a count of at least one resolvable result from the at least one remote resolving peer.

In one embodiment, a black list that maps the scheme to at least one of the multiple resolving peers not understanding the scheme is stored in the local resolving peer and is updated in every TTL (Time to Live).

In another embodiment, in the step (c), the local resolving peer transmits the target resolution type and the target to the at least one remote resolving peer each of which differs from the part of the multiple resolving peers retrievable from a black list with the scheme.

In another embodiment, in the step (c), the local resolving peer transmits the target resolution type, the scheme, and the target to the at least one remote resolving peer each of which is identical to one of the part of the multiple resolving peers in a white list and differs from the at least one of the multiple resolving peers retrievable from the black list with the scheme.

In another embodiment, the while list and the black list are generated based on at least one factor of a merchant location and a customer location.

In another embodiment, in the step (c), the local resolving peer transmits the target resolution type, the scheme, and the target to the at least one remote resolving peer based on one of a concurrent order and a sequential order.

To achieve the foregoing objective, the system for resolving a target includes:

A system for resolving a target includes a cross-peer transaction network, a subscriber device, and multiple resolving peers.

The multiple resolving peers are communicatively connected to the cross-peer transaction network with a part of the multiple resolving peers including at least one remote resolving peer and a local resolving peer.

The local resolving peer is communicatively connected to the subscriber, receives a scheme, a target, and a target resolution type from the subscriber device, determines if the target is resolvable to at least one identifier corresponding to the target resolution type, transmits the target resolution type, the scheme, and the target to the at least one remote resolving peer when the target is not resolvable at the absence of an internal error, and determines if the target is resolvable based on a count of at least one resolvable result from the at least one remote resolving peer.

Given the two-stage target resolution, when the local resolving peer fails to resolve target in the first-stage resolution for whatever reason, the at least one remote resolving peer in the second-stage target resolution provides more comprehensive resolving service eliminating the chance of not understanding the scheme of the original target information or understanding the scheme but being unable to resolve the target, thereby significantly enhancing the reliability of resolving the target. Meanwhile, by adopting the scheme caching approach for blocking transmission of the target to those resolving peers not understanding the scheme in the black list and the hint service approach for narrowing down transmission of the target to those resolving peers capable of resolving the target in the white list, the traffic flow resulting from the target information transmission between the first-stage target resolution and the second-stage resolution can be reasonably lowered in contrast to transmission of the target information to the second-stage target resolution without discrimination and the reduced traffic flow in turn leads to a fast and efficient target resolution. Therefore, the method and the system of the present invention have advantages over conventional techniques in delivering more reliable and responsive target resolution.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram showing an embodiment of a method for resolving a target in accordance with the present invention;

FIGS. 2A and 2B are associated with a flow diagram showing another embodiment of a method for resolving a target in accordance with the present invention;

FIG. 3 is a flow diagram showing a token-returning process in FIG. 2;

FIG. 4 is a flow diagram showing a process of acquiring original target information supplementing the method in FIGS. 1 and 2;

FIG. 5 is a flow diagram showing an embodiment of a process of payment a transaction using target resolution in accordance with the present invention;

FIG. 6 is a schematic diagram showing network architecture of an embodiment of a system for resolving a target in accordance with the present invention; and

FIG. 7 is a schematic diagram showing network architecture of another embodiment of a system for resolving a target in accordance with the present invention.

### DETAILED DESCRIPTION OF THE INVENTION

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

The described embodiments concern one method and one system for resolving a target when a target provider provides original target information to a subscriber to resolve the target in the original target information likely for a subsequent transaction. In general, the original target information can be provided in various forms as long as it can be used to generate a scheme and the target therefrom. The scheme here is a data format of the original target information. Depending on the nature of the transaction, either one of the target provider and the subscriber may present the original target information and the other acquires the target from the original target information in the transaction. And a target resolution type is usually determined by the nature of the transaction. In one embodiment, the target resolution type is assigned by the subscriber. The target may be information embedded in the original target information and be resolved to an identifier. In one embodiment, there are three types of identifiers associated with mobile transactions, namely, MSN (mobile subscriber number), MSID (merchant service universally-unique identifier), and MSU (both MSN and MSID), respectively corresponding to a target resolution type. In other words, a target resolution type is a type of identifier, such as MSN, MSID, and MSU in the above embodiment. This gist of the method or the system resides in two-stage target resolution, one performed by a local resolving peer and the other performed by at least one remote resolving peer. The local resolving peer and the at least one remote resolving peer pertain to a portion of multiple resolving peers in the system. For avoidance of a network congestion issue caused by broadcasting the target and the target resolution type to the remaining resolving peers in the system without selection, a scheme caching approach and a hint service approach are applied to address to the network congestion issue by reducing the number of queries to the remaining resolving peers for target resolution. For the network architecture of the target resolving system, a cross-peer transaction network is used to communicatively connected the multiple resolving peers, including a local resolving peer and the at least one remote resolving peer. The following description elaborates the implementation of the method and the system.

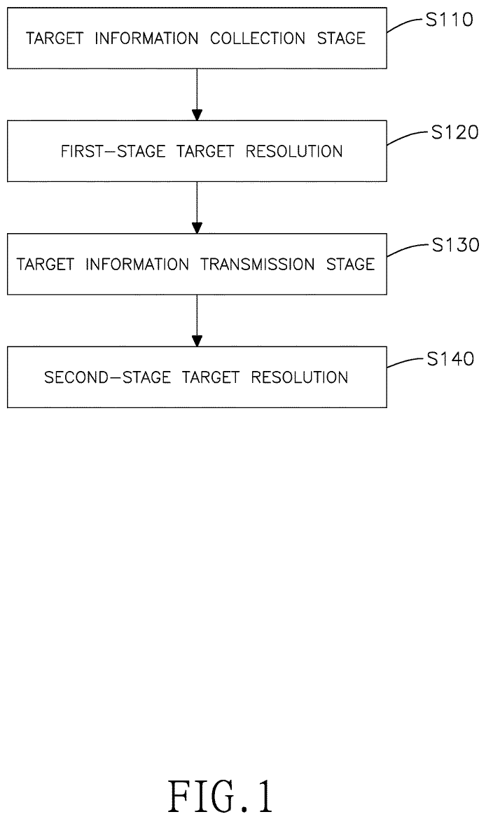

As outlined earlier, in one embodiment, a target resolving method may be used to facilitate a transaction between a subscriber and a target provider. In consideration of the trend of using mobile wallets for transactions, the target resolving method in FIG. 1 focuses on resolving the target to certain identifiers associated with mobile transaction services, namely, MSN for customers, MSID for merchants, and MSU for store cards which contain the identifier of both a customer and a merchant. The transaction here may include but is not limited to a payment transaction.

A target provider provides original target information of his/her own and communicates the original target information and a scheme of the original target information to the subscriber. Then, the subscriber extracts the target from the original target information and communicates the scheme, the target, and the target resolution type to the local resolving peer. The scheme of the original target information and the target resolution type may be pre-determined by the system. As a result, they may not need to be communicated from the target provider to the subscriber and further to the local resolving peer. As to the original target information, it is defined as the source information from which the target is extracted and is in the form of an information storage means, including but not limited to one of QR code, NFC (Near-field Communication) tag, voice signature, and fingerprint. The scheme of the original target information is a proprietary data format of the original target information supported by one payment service provider and in one embodiment, may be provided by the target provider to the subscriber. Types of the scheme include but are not limited to QR code scheme, NFC scheme, voice scheme, and fingerprint scheme each of which can be supported by a payment service provider. For example, PAY PAY as a payment service provider, may generate original target information in different schemes such as QR code scheme, NFC scheme, voice scheme, and fingerprint scheme. The target itself is information derived by extracting features embedded in the original target information, for example, by scanning QR code, sensing NFC tag, extracting voice signature from voice, or scanning fingerprint to extract the features and obtain the target according to the scheme of the original target information. The target may be in a format of a string.

From the perspective of transactional behavior, the subscriber may be a merchant and the target provider may be a customer. In that scenario, if a QR code is the scheme used for the original target information, the QR code is presented by the customer and possibly comes from the customer's portable/mobile device, for example, a mobile phone, and the merchant or an acquisition device, for example, a point-of-sale (POS) machine, of the merchant scans the customer's QR code to acquire the target, which is a QR code string. Alternatively, the subscriber may be a customer and the target provider may be a merchant. Under the circumstance, if still the scheme of QR code used for the original target information, the QR code is presented by the merchant and the customer's mobile device scans the merchant's QR code to acquire the QR code string.

Target resolution type is a type of identifier to which the target is resolved and in one embodiment may be a type of MSN, a type of MSID, or a type of MSU respectively corresponding to the target resolvable to an MSN, an MSID, or an MSN plus an MSID. The type of MSN is applied when the at least one identifier resolved from the target is related to the customer. The type of MSID is applied when the at least one identifier resolved from the target is related to the merchant. The type of MSU is applied when the at least one identifier resolved from the target is related to both the customer and the merchant. Examples of occasions involved with the types of MSN, MSID, and MSU are payment for a transaction with a customer's original target information, payment for a transaction with a merchant's original target information, and payment for a transaction with a store card's original target information. A store card stores values issued from the merchant to the customer. In one embodiment, the target resolution type is given by a customer or a merchant to its local resolving peer after acquiring the target from the original target information. For any occurrence of an expression that the target is resolved to the at least one identifier corresponding to the target resolution type in the present disclosure, it means that the at least one identifier resolved from the target can be identified locally at a resolving peer conducting the target resolution. Regarding the hardware architecture in the present disclosure, a local resolving peer and at least one remote resolving peer are a part of multiple resolving peers communicatively connected to a cross-peer transaction network. The local resolving peer service directly receives the target from the subscriber while each of the at least one remote resolving peer doesn't.

The method for resolving a target includes the following steps.

Step S110: A local resolving peer receives the target and a target resolution type from a subscriber. During a pre-processing stage before this step, the subscriber acquires the target and the target resolution type, for example by scanning QR code or sending NFC tag. In one embodiment, the target resolution type is pre-determined by the system such as an App installed on a customer's mobile device or a software installed on a merchant's POS device or server. At current step is for the local resolving peer to receive the target and the target resolution type from the subscriber for performing a subsequent first-stage target resolution.

Step S120: The local resolving peer determines if the target is resolvable to at least one identifier corresponding to the target resolution type. The current step is for the first-stage target resolution trying to resolve the target to at least one identifier. The at least one identifier, if the target is resolvable, may be one MSN when the target resolution type is of the type of MSN, one MSID when the target resolution type is of the type of MSID, or one MSN plus one MSID when the target resolution type is of the type of MSU. In one embodiment, the MSD identifies a globally unique mobile phone number which is associated to a globally unique customer; the MSID identifies a globally unique merchant ID which is associated to a globally unique merchant; and the MSU identifies a globally unique store card which is associated to a value issued by a merchant to a customer. When the local resolving peer determines that the target is not resolvable at the absence of any internal error upon resolving the target, perform the step S130. Otherwise, return a notice for successfully resolving the target without proceeding the steps S130 and S140.

Step S130: The local resolving peer transmits the target resolution type and the target to at least one remote resolving peer. The current step is a transmission stage. The at least one remote resolving peer may be one or more remote resolving peers. The network congestion issue mentioned earlier may arise when the local resolving peer broadcasts the target resolution type and the target without any selection or randomly broadcasts them to the remaining or all remote resolving peers and thus slows down the speed in resolving the target. As suggested earlier, the hint service approach used to tackle such network congestion issue will be elaborated later.

Step S140: The local resolving peer determines if the target is resolvable based on a count of at least one resolvable result from the at least one remote resolving peer. The current step is a second-stage target resolution. When each of the at least one remote resolving peer determines that the target is resolvable, the remote resolving peer will return one resolvable result to the local resolving peer. When the remote resolving peer determines that the target is not resolvable for whatever reason, it will return no resolvable result. The count of the overall resolvable result(s) returned to the local resolving peer is a criterion for the local resolving peer to decide if the target is resolvable. By virtue of the two-stage target resolution, as long as a target is resolved at either the first-stage target resolution or the second-stage target resolution, parties involved with the transaction in reliance on such indication will receive a green light for proceeding the transaction.

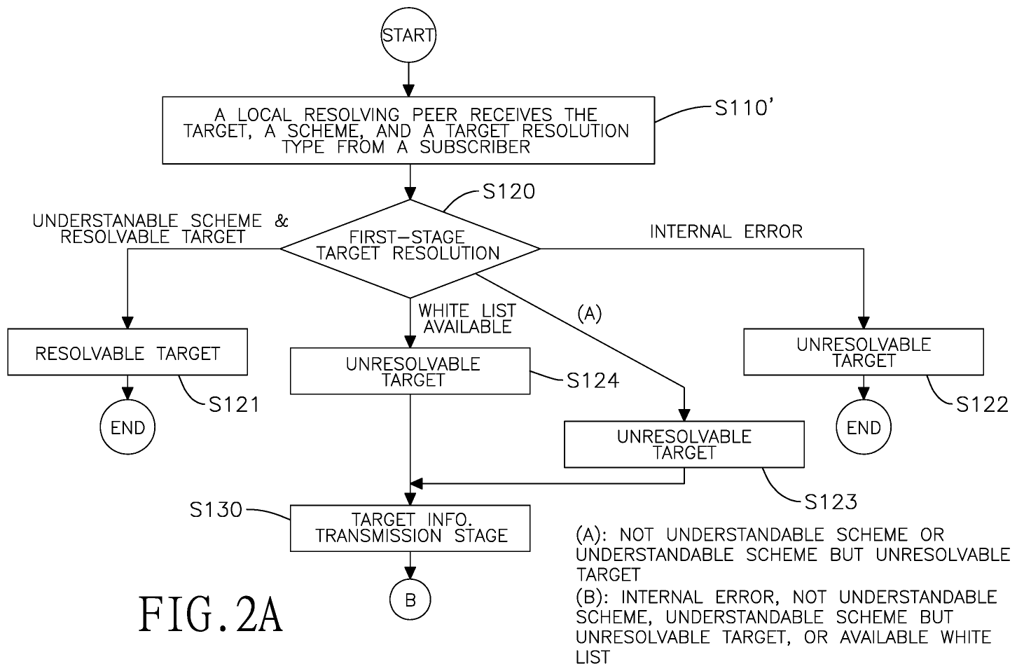

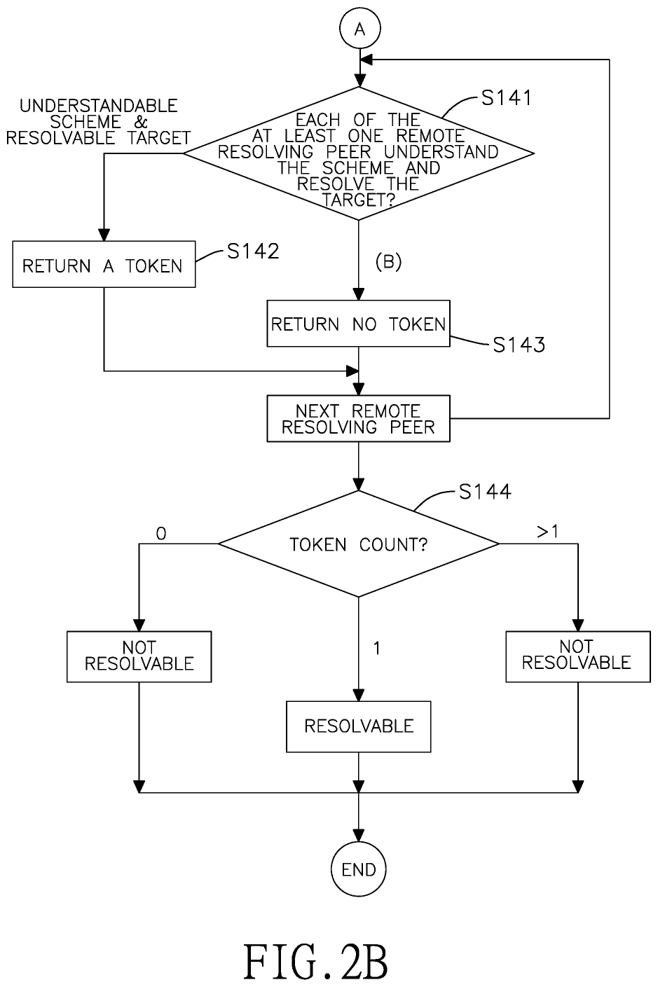

Further to the method illustrated in FIG. 1, a method for resolving a target shown in FIGS. 2A and 2B is a detailed version of the foregoing method and is identical to the foregoing method except that a step S110′ as a replacement of the Step S110 and steps S121 to S124 stemming from the determination results of the step S120 and steps S141 to S144 for replacing the step S140. For avoidance of duplication, only those steps for the method in FIGS. 2A and 2B which are different from and additional to the steps of the method in FIG. 1 are described below.

The following step S110′ is to replace the step S110 in FIG. 1.

Step S110′: A local resolving peer receives the target, a scheme, and a target resolution type from a subscriber. The distinction between the current step and the original step S110 resides in the scheme additionally communicated from the subscriber to the local resolving peer for the first-stage target resolution. In one embodiment, a target resolving system is implemented to generate and accept both the QR code scheme and NFC tag scheme, the subscriber needs to provide the scheme to the local resolving peer.

As illustrated in FIG. 2A, the following steps S121-S124 are the steps stemming from the determination result of the step S120 in FIG. 1.

Step S121: When understanding the scheme and resolving the target to the at least one identifier in the step S120, the local resolving peer determines that the target is resolvable and the steps S130 and S140 to S144 are skipped. The current step concludes that the target is resolvable to the at least one identifier without going for the second-stage target resolution when the local resolving peer understands the scheme and resolves the target to the at least one identifier.

Under the same high level scheme such as QR code scheme and NFC tag scheme, each high-level scheme may further include multiple low-level schemes (data format). For example, for a QR code scheme, if the target is a 13 digits QR code string and the target resolution type is MSN as a globally unique mobile phone number, the low-level scheme can be a data format of national code (3 digits), area code (3 digits) and local phone number (7 digits). Thus, a scheme can mean a high-level scheme or a low-level scheme or both, depending on the context. Each of the multiple resolving peers has a default list with at least one default scheme it can understand. Hence, if the scheme of the original target information is identical to one of the at least one default scheme in the default list of the local resolving peer, the scheme of the original target information is determined to be understandable by the local resolving peer. In one embodiment, the default list in the local resolving peers may be partially or completely different from that in the at least one remote resolving peer, which is a part of the multiple resolving peers. If the at least one remote resolving peer has completely the same default list as the local resolving peer, the second-stage target resolution may not be beneficial.

Step S122: When there is any internal error present upon resolving the target in the step S120, the local resolving peer determines that the target is not resolvable and the steps S130 and S140 to S144 are skipped. Unlike the step S121, the current step concludes that the target is not resolvable to the at least one identifier without going for the second-stage target resolution when the local resolving peer receives any internal error irrespective of whether it is caused by a hardware issue or a software issue upon resolving the target.

Step S123: When failing to understand the scheme or understanding the scheme but failing to resolving the target to the at least one identifier in the step S120, the local resolving peer determines that the target is not resolvable. The current step intends to determines that the target is not resolvable at the first-stage target resolution and get ready for the second-stage target resolution. There are two conditions required to be met to kick off the second-stage resolution. One is that the scheme is determined to be not understandable to the local resolving peer when the scheme is not in the default list of the local resolving peer. The other is that the scheme is in the default list of the local resolving peer but the at least one identifier resolved from the target is not found in the local resolving peer. When either one of the two conditions is met, the target is determined to be not resolvable to the at least one identifier and the second-stage target resolution can be started.

Step S124: When receiving a white list including a part of other resolving peers capable of resolving the target and suggested from a hint service at the local resolving peer in the step S120, the local resolving peer determines that the target is not resolvable. The current step determines that the target is not resolvable without leaving the remaining steps unexecuted when the local resolving peer receives the white list. The white list is a voluntary response and not every resolving peer will provide such hint service every time to itself or to other resolving peer upon resolving a target. Nevertheless, when the white list is available, the local resolving peer doesn't have to query every other resolving peer for target resolution but the part of other resolving peers in the white list, which could be a limited number of the entire resolving peers, thereby sorting out the fan-out issue.

As illustrated in FIG. 2B, the following steps S141-S144 are the steps for replacing the step S140 in FIG. 1.

Step S141: Each of the at least one remote resolving peer determines if the remote resolving peer understands the scheme and resolves the target to the at least one identifier corresponding to the target resolution type. The current step intends to determine if each of the at least one remote resolving peer understands the scheme and resolve the target at the second-stage target resolution. For scheme understanding, similar description can be found in the description for elaborating the step S121 and is thus not repeated here. When the remote resolving peer understands the scheme and resolves the target to the at least one identifier, perform the step S142. When there is any internal error, the remote resolving peer fails to understand the scheme, the remote resolving peer understands the scheme but fails to resolving the target to the at least one identifier, or the remote resolving peer returns the white list including the part of other resolving peers capable of resolving the target and suggested from the hint service at the remote resolving peer to the local resolving peer, perform the step S143.

Step S142: The remote resolving peer returns a token being mappable to the at least one identifier and indicating that the target is resolvable to the local resolving peer. The token here is equivalent to the resolvable result in the step S140 and may be encrypted data in an attempt to hide the at least one identifier from the local resolving peer who initiates the target resolution. As being mappable to the at least one identifier, the token can be used to map back to the at least one identifier during transaction using the token.

Step S143: The remote resolving peer returning no token. At the second-stage target resolution, when detecting presence of internal error, failure of understanding the scheme, success of understanding the scheme and failure of resolving the target, or availability of the white list, the remote resolving peer will return no token. It is also noted that the white list provided in the second-stage target resolution is meaningless for the second-stage target resolution and is therefore discarded.

Step S144: The local resolving peer determines that the target is resolvable when the count of the at least one token received from the at least one remote resolving peer is one or that the target is not resolvable when the count is zero or more than one. The current step intends to conclude that the target is resolvable when the count of the at least one token from the at least one remote resolving peer is one. With the count being zero or more than one, the local resolving peer determines that the target is not resolvable to the at least one identifier.

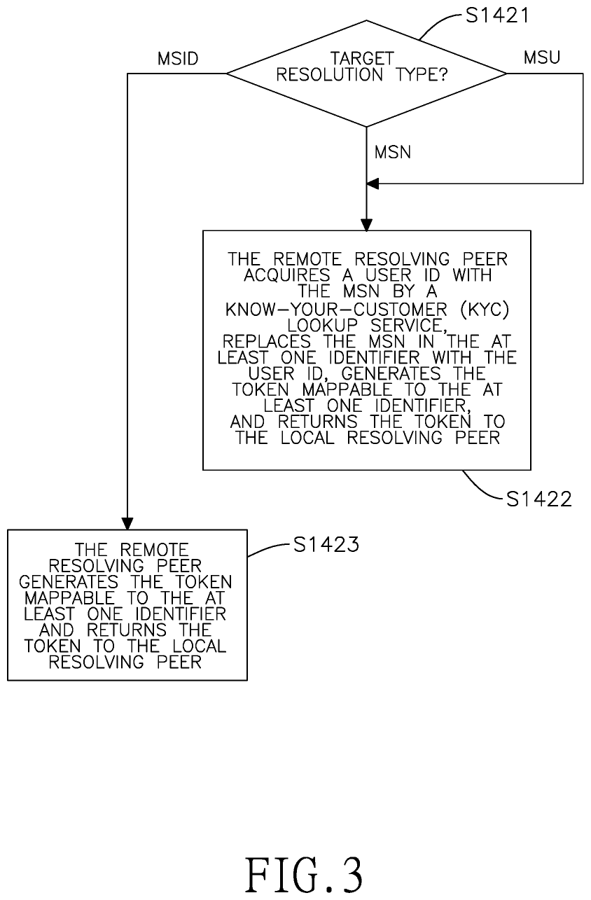

With reference to FIG. 3, the step S142 further includes the following steps.

Step S1421: The remote resolving peer determines the target resolution type. When the target resolution type is one type of MSN and MSU, perform step S1422. When the target resolution type is the type of MSID, perform step S1423.

Step S1422: The remote resolving peer acquires a user ID that identifies the target provider with the MSN of the at least one identifier by way of a know-your-customer (KYC) lookup service at the remote resolving peer or at an external server communicatively connected to the cross-peer transaction network, replaces the MSN in the at least one identifier with the user ID, generates the token mappable to the at least one identifier, and returns the token to the local resolving peer. Although the target provider may have more than one MSNs in his/her possession, the user ID is a unique identifier for identifying the target provider. The major concern of returning the token, which is encrypted information, instead of the MSN is to keep the user ID confidential to the local resolving peer which may not have any business or service relationship with the remote resolving peer. Meanwhile, compared with the user ID, the MSN may not be a unique identifier. In the case of the type of MSN for the target resolution type, the token will be used to map back to a corresponding MSN while in the case of the type of MSU, the token will be used to map back to corresponding MSN and MSID.

Step S1423: The remote resolving peer generates the token mappable to the at least one identifier and returns the token to the local resolving peer. In the case of the type of MSID, there is no need for the KYC lookup service since the MSID itself is a unique identifier. As a result, the token is generated by the remote resolving peer and is mappable to the MSID only.

Besides the hint service approach that provides the white list for the fan-out issue, the scheme caching approach that provides a black list is another counter-measure to the fan-out issue. Unlike the white list, the black list includes at least one scheme and at least one of the entire resolving peers not understanding and mappable to each of the at least one scheme. Each of the multiple resolving peers has a black list that is updated in every time-to-live (TTL), which is treated as a self-destruct time. The local resolving peer in the step S123 and each of the at least one remote resolving peer in the step S143 which fail to understand the scheme will be recorded in the next update of the black lists in the local resolving peer. At the step S130 for the target information transmission stage, one of the hint service approach and the scheme caching approach or both can be adopted. When the white list is available at the local resolving peer and the hint service approach is adopted alone, the local resolving peer transmits the scheme, the target, and the target resolution type to the at least one remote resolving peer which is mappable to the scheme in the white list. When the scheme caching approach is adopted alone, the local resolving peer transmits the scheme, the target, and the target resolution type to the at least one remote resolving peer each of which differs from the at least one of the entire resolving peers mappable to the scheme in the black list. When both the hint service approach and the scheme caching approach are adopted, the local resolving peer transmits the scheme, the target, and the target resolution type to the at least one remote resolving peer each of which is one of the part of the multiple resolving peers mappable to the scheme in the white list and differs from the at least one of the multiple resolving peers mappable to the scheme in the black list. As far as the way of transmission is concerned, the local resolving peer can transmit the scheme, the target, and the original target information to the at least one remote resolving peer in a concurrent or sequential manner. As a general rule, the while list and the black list may be generated based on at least one factor of a merchant location and a customer location.

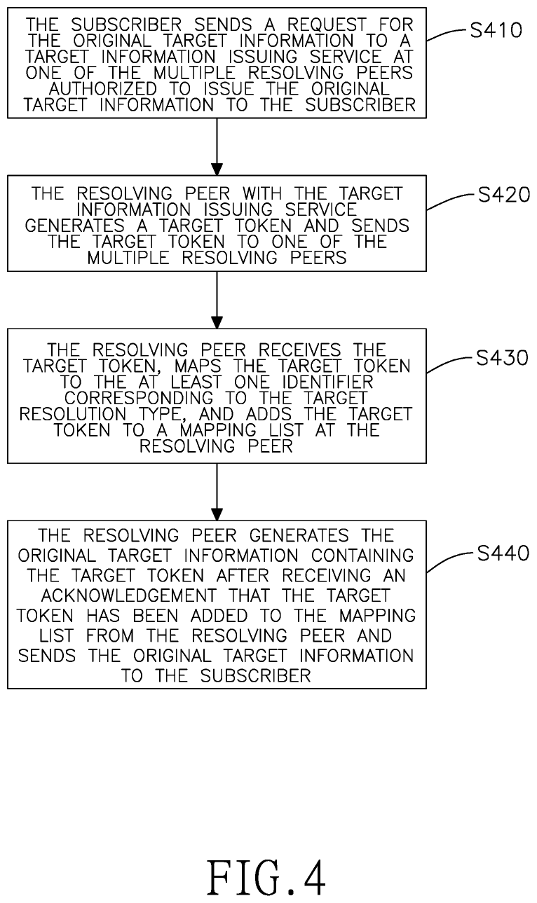

The method in FIGS. 1 and 2 further includes the following steps as illustrated in FIG. 4 for generating and acquiring the original target information.

Step S410: The subscriber sends a request for the original target information and the target resolution type to a target information issuing service at one of the multiple resolving peers authorized to issue the original target information to the subscriber. The target information issuing service may be offered from a backend server co-located at one the multiple resolving peers serving as a payment service provider.

Step S420: The resolving peer with the target information issuing service generates a target token and sends the target token to one of the multiple resolving peers. The target token may be encrypted information.

Step S430: The resolving peer receives the target token, maps the target token to the at least one identifier corresponding to the target resolution type, and adds the target token to a mapping list at the resolving peer. The current step intends to create a mapping relationship between the target token and the corresponding identifier associated with the subscriber. The target token can be used to map back to the at least one identifier when the original target information is used upon target resolution.

Step S440: The resolving peer generates the original target information containing the target token after receiving an acknowledgement that the target token has been added to the mapping list from the resolving peer and sends the original target information to the subscriber. The target token is the encrypted information contained in the original target information and can be acquired by retrieving and decoding the content of the original target information.

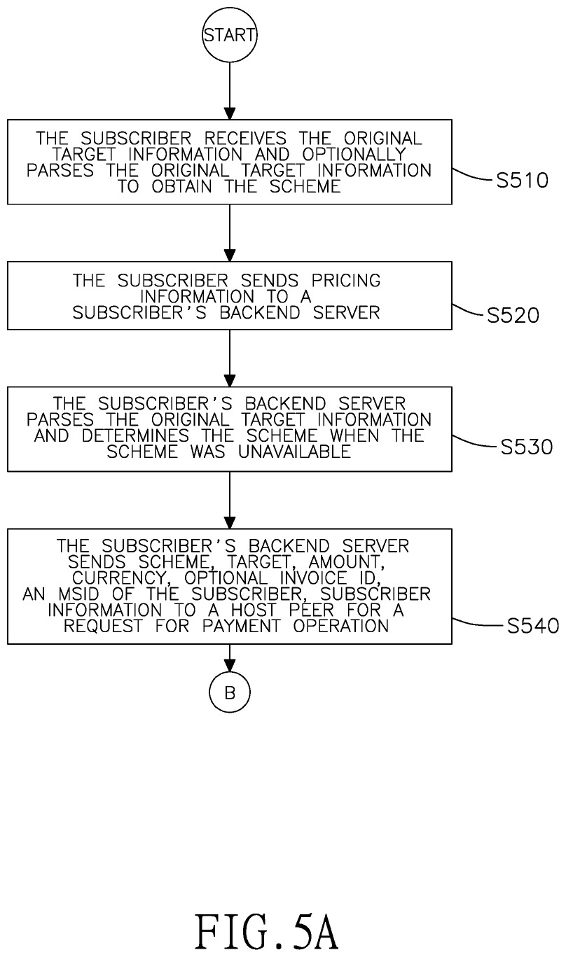

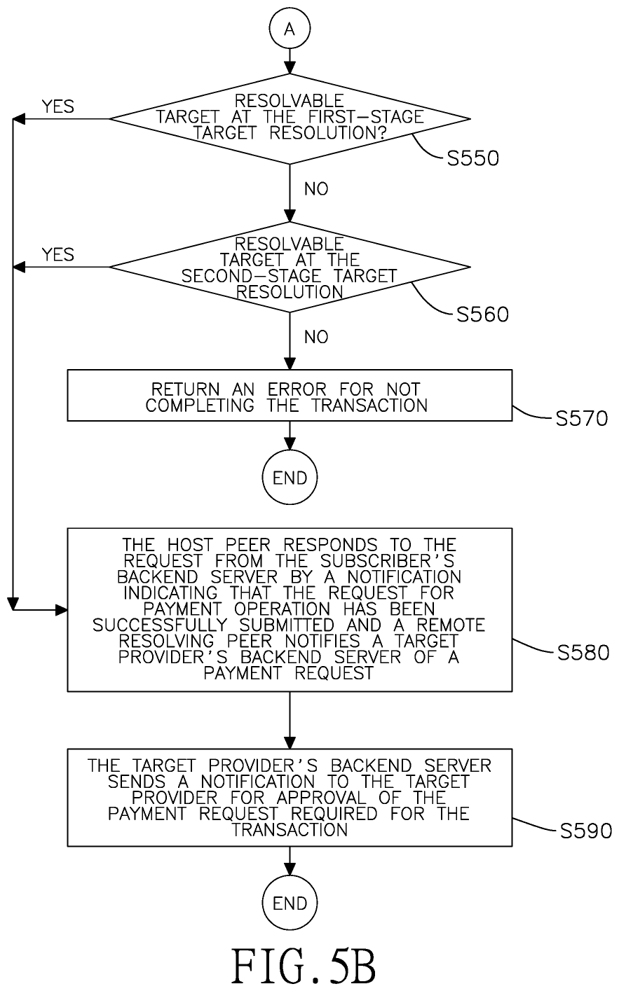

With reference to FIG. 5, a process adopting the technique of target resolution, which resolves the target of the target provider to an MSN before committing a payment transaction between the subscriber (merchant's POS machine) and the target provider (customer's mobile device), includes the following steps.

Step S510: The subscriber receives the original target information of the target provider and optionally parses the original target information to obtain the scheme of the original target information.

Step S520: The subscriber sends pricing information in terms of amount, currency, the original target information, the optional scheme, and an optional Invoice ID to a subscriber's backend server.

Step S530: Upon receiving the original target information from the subscriber, the subscriber's backend server parses the original target information and determines the scheme when the scheme was not provided by the subscriber in step S510, optionally generates an invoice-id when the invoice ID was not provided by the subscriber in step 520, determines the pricing information when the pricing information was not provided by the subscriber in the step S520.

Step S540: The subscriber's backend server sends scheme, target, amount, currency, optional invoice ID, an MSID of the subscriber, subscriber information (like merchant-name, address and so on) to a host peer for a request for payment operation. The host peer is communicatively connected to the cross-peer transaction network and is capable of performing transactions across peers for the subscriber and the target provider which are communicatively connected to the cross-peer transaction network.

Step S550: The host peer checks if a local resolving peer in communication with the cross-peer transaction network resolves the target to the MSN with the target and the scheme. When the local resolving peer fails to resolve the target, perform step S560. Otherwise, perform step S580.

Step S560: The host peer broadcasts the target and the scheme to at least one remote resolving peer in communication with the cross-peer transaction network and checks if the at least one remote resolving peer resolves the target to the MSN with the target and the scheme. When the at least one remote resolving peer fails to resolve the target, perform step S570. When there is one MSN resolvable from the target, perform step S580

Step S570: The host peer determines that the transaction is not completed and return an error in response to the subscriber's request for payment operation in the step S540.

Step S580: The host peer responds to the request from the subscriber's backend server by a notification indicating that the request for payment operation has been successfully submitted and in parallel, a remote resolving peer notifies a target provider's backend server of a payment request including the amount, the currency, the subscriber information (if supplied by the subscriber's backend server in the step S540), the invoice ID (if supplied by the subscriber's backend server in the step S540), and a resolved user ID.

Step S590: The target provider's backend server sends a notification to the target provider for approval of the payment request required for the transaction.

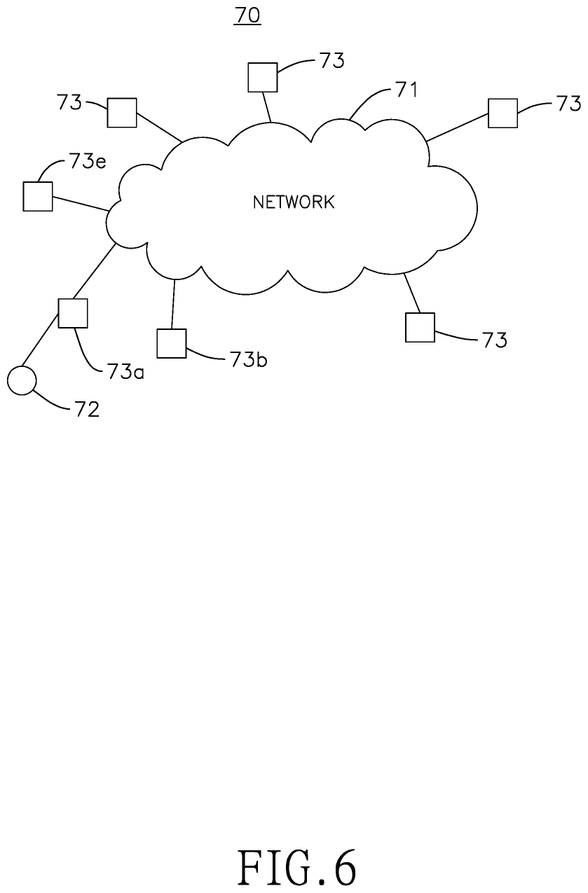

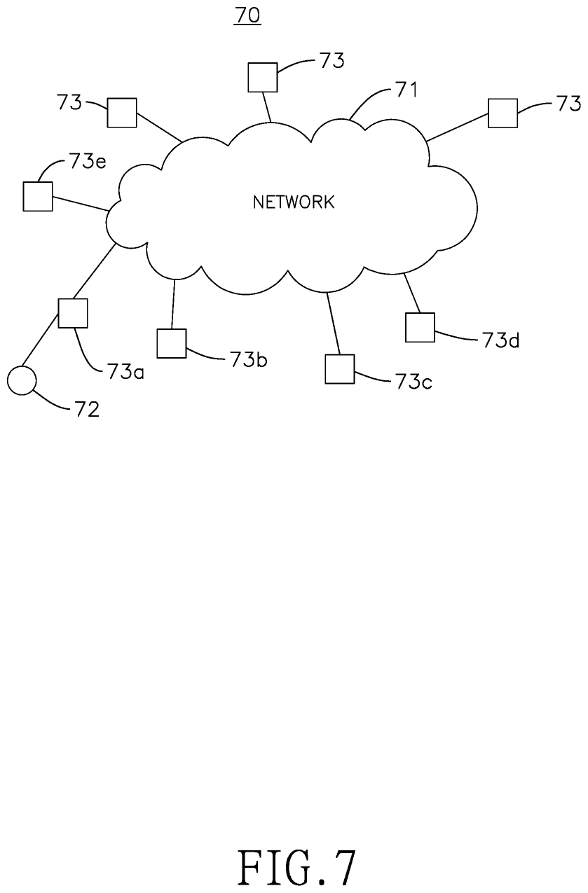

As can be seen from the foregoing description, a system appears to be behind the method for resolving a target in fulfillment of the method. With reference to FIGS. 6 and 7, a system for resolving a target 70 includes a cross-peer transaction network 71, a subscriber device 72, and multiple resolving peers 73. Before starting detailed description for the system, it should be noted that the system inherits definitions of terms, concepts, and embodiments from the foregoing method.

In one embodiment, the cross-peer transaction network 71 is implemented based on distributed ledger technology. The subscriber device 72 is owned by a subscriber and acquires original target information, a scheme and a target resolution type from a target provider (not shown). In one embodiment, the scheme and the target resolution type may be pre-determined by the system and thus the target provider may not need to provide such information. When owned by a customer, the subscriber device 72 may be a mobile device including but not limited to a mobile phone, a tablet personal computer (PC), or a laptop computer. When owned by a merchant, the subscriber device 72 may be a point-of-sale (POS) machine. The multiple resolving peers 73 are communicatively connected to the cross-peer transaction network 71 and include a local resolving peer 73a and at least one remote resolving peer 73b, 73c, 73d, which are a part of the multiple resolving peers 73. FIGS. 6 and 7 show the embodiments with a single remote resolving peer 73b and multiple remote resolving peers 73b, 73c, 73d respectively. In one embodiment, each of the multiple resolving peer 73 is a node run by a telecom carrier capable of managing transactions of digital properties, such as digital currencies, digital securities, digital bonds, digital futures, and digital precious metals. The local resolving peer 73a is communicatively connected to the subscriber device 72 and the transaction service provider of the subscriber while the at least one remote resolving peer 73b, 73c, 73d is not in direct communication with the subscriber device 72 (not its transaction service provider). The local resolving peer 73a receives a target, a scheme (optional), and a target resolution type from the subscriber device 72 and determines if the target is resolvable to at least one identifier corresponding to the target resolution type, and transmits the target resolution type and the target to the at least one remote resolving peer 73b, 73c, 73d when the target is not resolvable at the absence of an internal error, and determines if the target is resolvable based on a count of at least one resolvable result from the at least one remote resolving peer 73b, 73c, 73d.

As the hint service approach is involved with the white list, when receiving the white list including a part of the multiple resolving peer 73 capable of resolving the target and suggested from a hint service at the local resolving peer 73a, the local resolving peer 73a transmits the target resolution type, the scheme, and the target to the at least one remote resolving peer 73b, 73c, 73d. On the other hand, scheme caching approach is involved with a black list. The local resolving peer 73a stores a black list that maps the scheme to a part of the multiple resolving peers 73 not understanding the scheme and updates the black list in every TTL (Time to Live). With the black list taking effect only, the local resolving peer 73a transmits the target, the scheme, and the target resolution type to the at least one remote resolving peer 73b, 73c, 73d each of which differs from the at least one of the multiple resolving peers 73 retrievable from the black list with the scheme. With the white list taking effect only, the local resolving peer 73a transmits the target, the scheme, and the target resolution type to the at least one remote resolving peer 73b, 73c, 73d each of which is identical to one of the part of the multiple resolving peers 73 in the white list retrievable with the scheme. With both the white list and the black list, the local resolving peer 73a transmits the target resolution type, the scheme, and the target to the at least one remote resolving peer 73b, 73c, 73d each of which is identical to one of the part of the multiple resolving peers 73 in the white list and differs from the at least one of the multiple resolving peers 73 retrievable from the black list with the scheme. Besides the scheme caching approach and the hint service approach, the way of transmission for the local resolving peer 73a to transmit the target, the scheme, and the target resolution type to the at least one remote resolving peer 73b, 73c, 73d may be performed in a sequential order or a concurrent order selected based on a traffic flow condition of the system 70.

The system 70 further includes a target issuing peer 73e being one of the multiple resolving peers that is authorized to issue the original target information to the subscriber device 72 and is communicatively connected to the cross-peer transaction network 71. The resolving peer may be co-located with a backend server run by a payment service provider and issuing the original target information. To request for the original target information, the subscriber device 72 first sends a request for the original target information and the target resolution type to the target issuing peer 73e. The target issuing peer 73e then generates a target token and sends the target token to one of other resolving peers 73 upon receiving the request and the target resolution type. The other resolving peer 73 receives the target token, maps the target token to the at least one identifier corresponding to the target resolution type, and adds the target token to a mapping list at the other resolving peer 73. The target issuing peer 73e generates the original target information containing the target token after receiving an acknowledgement that the target token has been added to the mapping list of the other resolving peer 73 and sends the original target information to the subscriber device 72. Thus, when the target resolution type is one type of MSN and MSU, the remote resolving peer 73b, 73c, 73d acquires a user ID that identifies the target provider with the MSN of the at least one identifier by way of a know-your-customer (KYC) lookup service at the remote resolving peer 73b, 73c, 73d or at an external KYC lookup service, replaces the MSN in the at least one identifier with the user ID, generates the token mappable to the at least one identifier, and returns the token to the local resolving peer 73a. When the target resolution type is MSID, the remote resolving peer 73b, 73c, 73d generates the token mappable to the at least one identifier and returns the token to the local resolving peer 73a.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for resolving a target comprising:
(a) a local resolving peer receiving the target and a target resolution type from a subscriber communicatively connected to the local resolving peer;
(b) the local resolving peer determining if the target is resolvable to at least one identifier corresponding to the target resolution type;
(c) when the target is not resolvable, the local resolving peer transmitting the target resolution type, and the target to at least one remote resolving peer, wherein the local resolving peer and the at least one remote resolving peer are a part of multiple resolving peers communicatively connected to a cross-peer transaction network; and
(d) the local resolving peer determining if the target is resolvable based on a count of at least one resolvable result from the at least one remote resolving peer.

2. The method as claimed in claim 1, wherein in the step (a), the local resolving peer further receives a scheme of the original target information.

3. The method as claimed in claim 1, wherein the subscriber is a merchant and the target provider is a customer, or the subscriber is a customer and the target provider is a merchant.

4. The method as claimed in claim 2, wherein the scheme is one of a QR code scheme, an NFC scheme, a voice scheme, and a fingerprint scheme.

5. The method as claimed in claim 4, wherein the subscriber acquires the target from the target provider by scanning QR code, sensing NFC tag, extracting the voice signature from voice, or scanning the fingerprint.

6. The method as claimed in claim 1, wherein the target resolution type is one type of MSN (mobile subscriber number), MSID (merchant service universally-unique identifier), or MSU (MSN and MSID).

7. The method as claimed in claim 6, wherein when the target resolution type is the type of MSN, MSID, or MSU, the local resolving peer resolves the target to the at least one identifier including one MSN, one MSID, or one MSN and one MSID corresponding to the target resolution type being the type of MSN, MSID, or MSU.

8. The method as claimed in claim 2, wherein the step (b) further comprises:
(b1) when understanding the scheme and resolving the target to the at least one identifier, the local resolving peer determining that the target is resolvable and skipping the steps (c) and (d);
(b2) when there is any internal error upon resolving the target, the local resolving peer determining that the target is not resolvable and skipping the steps (c) and (d);
(b3) when failing to understand the scheme or understanding the scheme but failing to resolving the target to the at least one identifier, the local resolving peer determining that the target is not resolvable; and
(b4) when receiving a white list including a part of the multiple resolving peers capable of resolving the target and suggested from a hint service at the local resolving peer, the local resolving peer determining that the target is not resolvable, wherein the white list is a voluntary response returned from each of the multiple resolving peers and the hint service is provided in each of the multiple resolving peers.

9. The method as claimed in claim 8, wherein the step (d) further comprises:
(d1) each of the at least one remote resolving peer determining if the remote resolving peer understands the scheme and resolves the target to the at least one identifier corresponding to the target resolution type;
(d2) when the remote resolving peer understands the scheme and resolves the target to the at least one identifier, the remote resolving peer returning a token being mappable to the at least one identifier and indicating that the target is resolvable to the local resolving peer, wherein the token is the resolvable result;
(d3) when there is any internal error, the remote resolving peer fails to understand the scheme, the remote resolving peer understands the scheme but fails to resolving the target to the at least one identifier, or the remote resolving peer returns the white list including the part of the multiple resolving peers capable of resolving the target and suggested from the hint service at the remote resolving peer, the remote resolving peer returning no token; and
(d4) the local resolving peer determining that the target is resolvable when the count of the at least one token received from the at least one remote resolving peer is one or that the target is not resolvable when the count is zero or more than one.

10. The method as claimed in claim 9, wherein a black list that maps the scheme to at least one of the multiple resolving peers not understanding the scheme is stored in the local resolving peer.

11. The method as claimed in claim 10, wherein in the steps (b3) and (d3), the local resolving peer and the at least one remote resolving peer that fail to understand the scheme are stored in the black list of the local resolving peer in a next update of the black list and are mappable to the scheme.

12. The method as claimed in claim 10, wherein in the step (c), the local resolving peer transmits the target resolution type and the target to the at least one remote resolving peer each of which differs from the part of the multiple resolving peers retrievable from the black list with the scheme.

13. The method as claimed in claim 10, wherein in the step (c), the local resolving peer transmits the target resolution type, the scheme, and the target to the at least one remote resolving peer each of which is identical to one of the part of the multiple resolving peers in the white list and differs from the at least one of the multiple resolving peers retrievable from the black list with the scheme.

14. The method as claimed in claim 13, wherein the while list and the black list are generated based on at least one factor of a merchant location and a customer location.

15. The method as claimed in claim 1, wherein in the step (c), the local resolving peer transmits the target resolution type, the scheme, and the target to the at least one remote resolving peer based on one of a concurrent order and a sequential order.

16. The method as claimed in claim 9, wherein the step (d2) further comprises:
the remote resolving peer determining the target resolution type;
when the target resolution type is one type of MSN and MSU, the remote resolving peer acquiring a user ID that identifies the target provider with the MSN of the at least one identifier by way of a know-your-customer (KYC) lookup service at the remote resolving peer or at an external KYC lookup service, replacing the MSN in the at least one identifier with the user ID, generating the token mappable to the at least one identifier, and returning the token to the local resolving peer; and
when the target resolution type is MSID, the remote resolving peer generating the token mappable to the at least one identifier and returning the token to the local resolving peer.

17. The method as claimed in claim 9, further comprising:
the subscriber sending a request for the original target information with the target resolution type to a target issuing peer being one of the multiple resolving peers and authorized to issue the original target information to the subscriber;
the target issuing peer generating a target token and sending the target token to one of the multiple resolving peers, wherein the target token is encrypted information;
the resolving peer receiving the target token, mapping the target token to the at least one identifier corresponding to the target resolution type, and adding the target token to a mapping list at the resolving peer; and
the target issuing peer generating the original target information containing the target token after receiving an acknowledgement that the target token has been added to the mapping list of the resolving peer and sending the original target information to the subscriber.

18. The method as claimed in claim 1, wherein the local resolving peer service-binds the subscriber and the at least one remote resolving peer do not service-bind the subscriber.

19. The method as claimed in claim 1, wherein the cross-peer transaction network is a distributed ledger network capable of conducting cross-peer transactions and each of the multiple resolving peers is a node communicatively connected to the cross-peer transaction network and run by a telecom carrier capable of managing transactions of digital properties.

20. A system for resolving a target, comprising:
a cross-peer transaction network;
a subscriber device; and
multiple resolving peers communicatively connected to the cross-peer transaction network with a part of the multiple resolving peers including:
at least one remote resolving peer; and
a local resolving peer communicatively connected to the subscriber, receiving a target, and a target resolution type from the subscriber device, determining if the target is resolvable to at least one identifier corresponding to the target resolution type, transmitting the target resolution type, and the target to the at least one remote resolving peer when the target is not resolvable, and determining if the target is resolvable based on a count of at least one resolvable result from the at least one remote resolving peer.

21. The system as claimed in claim 20, wherein the original target information can be categorized by a scheme which is one of QR (Quick Response) code, NFC (Near field Communication) tag, voice, and fingerprint.

22. The system as claimed in claim 21, wherein the subscriber receives the target from the target provider by scanning QR code, sensing NFC tag, extracting voice signature from voice, or scanning the fingerprint.

23. The system as claimed in claim 20, wherein the target resolution type is one type of MSN (mobile subscriber number), MSID (merchant service universally-unique identifier), or MSU (MSN and MSID).

24. The system as claimed in claim 6, wherein when the target resolution type is the type of MSN, MSID, or MSU, the local resolving peer resolves the target to the at least one identifier including one MSN, one MSID, or one MSN and one MSID corresponding to the type of MSN, MSID, or MSU for the target resolution type.

25. The system as claimed in claim 20, wherein when receiving a white list including the a part of the multiple resolving peer capable of resolving the target and suggested from a hint service at the local resolving peer, the local resolving peer transmits the target resolution type, the scheme, and the target to the at least one remote resolving peer each of which is identical to one of the part of the multiple resolving peers in the white list, wherein the white list is a voluntary response from each of the multiple resolving peers and the hint service is provided in each of the multiple resolving peers.

26. The system as claimed in claim 20, wherein each of the at least one remote resolving peer returns a token being mappable to the at least one identifier and indicating that the target is resolvable to the local resolving peer when the remote resolving peer understands the scheme and resolves the target to the at least one identifier and determines that the target is resolvable when the count of the at least one token received from the at least one remote resolving peer is one or that the target is not resolvable when the count is zero or more than one, wherein the token is the resolvable result.

27. The system as claimed in claim 25, wherein the local resolving peer stores a black list that maps the scheme to a part of the multiple resolving peers not understanding the scheme and updates the black list in every TTL (Time to Live).

28. The method as claimed in claim 27, wherein the local resolving peer and the at least one remote resolving peer that fail to understand the scheme are stored in the black list by the local resolving peer in a next update of the black list and are mappable to and retrievable with the scheme.

29. The system as claimed in claim 27, wherein the local resolving peer transmits the target resolution type, the scheme, and the target to the at least one remote resolving peer each of which differs from the at least one of the multiple resolving peers retrievable from the black list with the scheme.

30. The system as claimed in claim 27, wherein the local resolving peer transmits the target resolution type, the scheme, and the target to the at least one remote resolving peer each of which is identical to one of the part of the multiple resolving peers in the white list and differs from the at least one of the multiple resolving peers retrievable from the black list with the scheme.

31. The system as claimed in claim 27, wherein the while list and the black list are generated based on at least one factor of a merchant location and a customer location.

32. The system as claimed in claim 20, wherein the local resolving peer transmits the target resolution type, the scheme, and the target to the at least one remote resolving peer based on one of a concurrent order and a sequential order.

33. The system as claimed in claim 23, wherein when the target resolution type is one type of MSN and MSU, the remote resolving peer acquires a user ID that identifies the target provider with the MSN of the at least one identifier by way of a know-your-customer (KYC) lookup service at the remote resolving peer or at an external KYC lookup service, replaces the MSN in the at least one identifier with the user ID, generates the token mappable to the at least one identifier, and returns the token to the local resolving peer; and
when the target resolution type is MSID, the remote resolving peer generates the token mappable to the at least one identifier and returns the token to the local resolving peer.

34. The system as claimed in claim 9, wherein the multiple resolving peers further comprises a target issuing peer communicatively connected to the cross-peer transaction network and authorized to issue the original target information to the subscriber device, wherein
the target issuing peer generates a target token and sends the target token to one of the multiple resolving peers after receiving a request for the original target information and the target resolution type from the subscriber device for the resolving peer to add the target token that is mappable to the at least one identifier corresponding to the target resolution type to a mapping list at the resolving peer, and generates the original target information containing the target token after receiving an acknowledgement that the target token has been added to the mapping list from the resolving peer and sends the original target information to the subscriber device, wherein the target token is encrypted information.

35. The system as claimed in claim 20, wherein the local resolving peer service-binds the subscriber device and the at least one remote resolving peer do not service-binds the subscriber device.

36. The system as claimed in claim 20, wherein the cross-peer transaction network is a distributed ledger network capable of conducting cross-peer transactions and each of the multiple resolving peers is a node communicatively connected to the cross-peer transaction network and run by a telecom carrier capable of managing transactions of digital properties.
